(19) United States
(12) Patent Application Publication
(10) Pub. No.: US 2009/0076976 A1
(43) Pub. Date: Mar. 19, 2009

(54) GLOBAL RELATIVE MARKET CAPITALIZATION

(76) Inventors: Xin Yan, Bellevue, WA (US); Kelly L. Haughton, Gig Harbor, WA (US); Pradeep V. Velvadapu, Seattle, WA (US); Barry E. Feldman, Olalla, WA (US); Rolf J. Agather, Lake Tapps, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/857,403

(22) Filed: Sep. 18, 2007

(51) Int. Cl. G06Q 50/00

(52) U.S. Cl. 705/36 R

(57) ABSTRACT

A method of constructing one or more global cap-size stock indexes. The method includes aggregating securities traded in a plurality of regions of the world into a single pool. Optionally, the securities may be screened to remove securities that are not available for investment by foreign investors. Additionally, a portion of the securities issued by companies having small company total market capitalizations may be screened from the pool. Then, the method determines a global market capitalization associated with each security in the pool. Finally, a portion of the securities is assigned to one of the global cap-size stock indexes based on the global market capitalization associated with the securities and one or more threshold values calculated as a function of the global market capitalizations of the securities in the pool. The global market capitalization associated with each security may include the company total market capitalization of the security's issuing company.

### BACKGROUND OF THE INVENTION

1. Field of the Invention

The present invention is directed to methods of creating and/or reconstituting a global stock index including securities issued by companies having a selected level of market capitalization.

2. Description of the Related Art

Stock market indexes are intended to represent an entire stock market or a portion of it and thus track changes in the market or the portion thereof over time. One purpose of an index is to serve as a performance benchmark. It measures an active investment portfolio's exposure and performance to the market opportunity set by representing a particular market or a portion of it. An index also serves as an asset class proxy by representing characteristics of an asset class without the influence of active management. Each index can have its own calculation methodology and is usually expressed in terms of a change from a base value. Thus, the percentage change is more important than the actual numeric value.

Indexes are created using various aggregations of securities. For example, some market indexes are intended to represent an entire stock market of a country or region and thus may be used to track changes in that market over time. Other indexes may include only securities of a particular type, securities issued by companies of a certain level of market capitalization, securities issued by companies within a particular industry, securities issued by companies belonging to a particular classification (e.g., growth stocks or value stocks), and so forth.

A company's market capitalization is defined as the number of securities (e.g., stock) issued by a company multiplied by their market value. As used herein, the term “cap” refers to market capitalization. Companies can be grouped and/or ranked by the magnitude of their market capitalization. In fact, many indexes include securities issued by companies having a particular market capitalization. For example, companies with small market capitalizations may be classified as small cap while companies with large market capitalizations may be classified as large cap. An index comprised of small cap companies may be referred to as a small cap index. Similarly, an index comprised of large cap companies may be referred to as a large cap index. Such indexes may be referred to as cap-size indexes.

Total market capitalization is the sum of the market capitalizations of all companies within a particular market. Therefore, each company whose stock is traded within a particular market contributes to the total market capitalization of that market and the company's market capitalization corresponds to a percentage of the total market capitalization. Some indexes select securities based on capturing a predetermined percentage of the market. By way of non-limiting example, an index can include the stocks of companies that combined represent 98% of the market. Such an index may be divided into two or more sub-indexes based on the market capitalizations of the companies. These sub-indexes are a type of cap-size index. For example, an index representing 98% of the market may be divided into two or more cap-size indexes (e.g., a small cap index and a large cap index). Likewise, the index representing 98% of the market may be divided into a small cap index, a mid cap index, and a large cap index.

The need for cap-size indexes is based on a well-documented phenomenon known as “cap-size effect” first observed in the U.S. market by the Frank Russell Company over twenty years ago. Stated simply, cap-size effect refers to the tendency of a stock of a large cap company in a selected market to behave like the stocks of other large cap companies in that market, and the tendency of a stock of a small cap company in a selected market to behave like the stocks of other small cap companies in the selected market.

Using conventional approaches, a market is frequently defined as a country. Therefore, a market index typically measures the value of the stock market or a portion thereof for a particular country (e.g., United States, Japan, France, Germany, etc.). In more recent years, a need has arisen for regional and global indexes. Traditional regions include Europe, Asia, Asia Pacific, Latin America, and North America. Under the conventional approaches, global indexes are constructed by first analyzing each country or region and then aggregating the results. For example, a large cap index will be determined for each country or region. Then, the large cap indexes will be combined to form a global large cap index.

The conventional approach considers each country or in some cases, each region separately because investment professionals believe the relationship between securities within a country or region is significant. Particularly, that relationship is more significant than any relationship between securities located in different countries or regions having a similar market capitalization. In other words, conventional wisdom in the art teaches that securities should be analyzed according to the country in which the security trades. Further, securities from different countries should be analyzed together as a single pool only if the countries are related in some manner (e.g., the countries are from the same geographic region).

Unfortunately, this conventional approach has several drawbacks. First, it may classify companies having very different market capitalizations in the same cap-size index, or alternatively, companies with similar market capitalizations may be classified in a different cap-size index simply because they are located in different countries or regions. For example, on average the total market capitalization for companies considered large cap in Europe is about $4 billion and about $2 billion in Asia. If the European and Asian markets are divided into small cap companies and large cap companies using the conventional approach of classifying a predetermined portion of the companies having the smallest market capitalizations as small cap companies and classifying the remaining companies as large cap companies, a smaller market capitalization will qualify an Asian company as a large cap company than is required to qualify a European company as a large cap company in Europe. Similarly, a large cap market capitalization cut-off (i.e., a minimum market capitalization, companies having market capitalizations above the cut-off are considered a large cap company) would be very different Slovenia and Canada. Combining securities issued by large cap companies in Slovenia and Canada into a broader large cap index creates a mix of securities that are not similar in size and thus do not accurately measure the large cap market. Further, this inconsistency across prior art global indexes can generate substantial cap-size overlap when combined into broader indexes, which reduces an index's ability to represent accurately what it was intended to measure.

Second, prior art global market cap-size indexes may not measure what is of most interest to investors. Some investors wish to invest in companies having at least a particular level of market capitalization. For example, global money managers frequently wish to consider securities issued by companies of a specific market capitalization size (e.g., any security issued by a company with a market capitalization larger than $2 billion). Such managers look at company size globally, not using a country-by-county or region-by-region cap-size approach. However, because prior art approaches create inconsistent cap-size determinations and over-lapping cap-size indexes, these global money managers cannot rely on prior art indexes to help them make decisions related to global market capitalization. In other words, while companies having at least a $2 billion USD market capitalization in the United States might qualify as a large cap company, global money managers cannot use a global large cap index to evaluate companies world wide having at least a $2 billion USD market capitalization because prior art global market large cap indexes simply do not provide that information.

Another approach includes dividing a preexisting global index into two cap-size indexes using single threshold value. The threshold value is determined by owners of the index and as global market capitalizations change, must be updated from time to time. For example, Standard & Poor's/Citigroup (“S&P/Citigroup”) a division of The McGraw-Hill Companies, Inc., headquartered in New York, N.Y., owns a global index of securities that it refers to as a Broad Market Index (“BMI”). The securities are chosen for inclusion in the BMI using a country-by-country approach. However, after the BMI index is assembled, the S&P/Citigroup's Cap Range Index Series are created using a single threshold value (e.g., $X billion USD) to divide the BMI index into securities issued by large cap-size companies (i.e., companies having total company market capitalizations greater than $X billion USD) and securities issued by small cap-size companies (i.e., companies having total company market capitalizations less than $X billion USD).

Unfortunately, this approach creates a division between two cap-sizes that is subjective and somewhat arbitrary. Typically, the threshold value is determined by a committee and represents a compromise between competing concerns. Investors and financial professionals cannot predict when the threshold value will be updated; and, even if timing of threshold value updates are known, investors and financial professionals cannot predict what the new threshold value may be. Further, changing the threshold value may assign a large number of securities to a different cap-size index, which would cause investors in funds tracking the index to incur fees associated with buying and selling securities.

Therefore, a need exists for a method of constructing a global cap-size index that avoids one or more of the drawbacks present in prior art. The present application provides this and other advantages as will be apparent from the following detailed description and accompanying figures.

### BRIEF DESCRIPTION OF THE SEVERAL VIEWS OF THE DRAWING(S)

FIG. 1 is a flow diagram of an exemplary embodiment of a method of constructing a global market cap-size index.

### DETAILED DESCRIPTION OF THE INVENTION

### Definition of Terms

Unless defined otherwise, technical and financial terms used herein have the same meaning as commonly understood by one of ordinary skill in the art to which this invention belongs. For purposes of the present invention, the following terms are defined below.

Co-listing and Cross Listing Security: a security having shares traded on more than one exchange. The exchanges may include one or more domestic exchanges, one or more foreign exchanges, and a combination thereof.

Company: an entity that issued one or more securities traded in the global market.

Company Total Market Capitalization: the sum of the market capitalizations of all securities issued by a company.

Depositary Receipt: a negotiable financial instrument issued by a bank to represent a foreign company's publicly traded securities. The depositary receipt trades on a local stock exchange. Depositary receipts make it easier to buy shares in foreign companies. When the depositary bank is in the U.S., the instruments are known as American Depositary Receipts (“ADRs”). Banks outside of the U.S. issue global depositary receipts (“GDRs”).

Domestic Exchange: with respect to a security, an exchange residing in the same country in which the company that issued the security was formed.

Foreign Investors: investors from a country other than that in which a security is traded. For example, a U.S. citizen is a foreign investor if he/she is trading a security on a Chinese exchange.

Dual Listing Company: two listed companies under a contractual arrangement that operate as if they were a single economic enterprise, but retain separate legal identities, tax residencies, and stock exchange listings. Dual-listed companies have a different set of shareholders, but share ownership of all business operations. Additionally, shareholders retain existing shares with economic interest in the combined assets of both companies, and shareholders of each company have equivalent dividend, capital, and voting rights on a per share basis. An example of a dual-listed company is Unilever (UK) and Unilever NV (Netherlands).

Equity: a security representing an ownership interest in a company.

Free-Float Adjusted Market Capitalization: free-float adjusted market capitalization is calculated by multiplying a security's price by the number of shares readily available in the market. Instead of using all of the shares outstanding (as would be done using a full-market capitalization method), the free-float method excludes locked-in shares (such as shares in a large personal holding owned by the company itself or by a government) because such shares are not readily available for trading. The free-float method is typically considered to be a better way of calculating market capitalization because the free-float method provides a more accurate reflection of market movements. The resulting market capitalization calculated using a free-float methodology is smaller than a market capitalization calculated using the full-market capitalization method.

Foreign Exchange: with respect to a security, an exchange residing in a country other than the country in which the company that issued the security was formed.

Global Cap-Size Index and Global Market Cap-Size Index: an index including securities traded in the global market, each security having been included in the global cap-size index because the company that issued the security had a global market capitalization that satisfied one or more size requirements.

Global Investable Market: a collection of investable securities traded on exchanges located all over the world. The global investable market is distinguishable from a traditional market, such as a country or a region (e.g., Asia, Europe, and the like), because the global investable market includes securities traded in countries and regions that were not traditionally combined and analyzed together as a single market.

Global Investable Total Market Capitalization: the sum of all of the total market capitalizations of securities issued by companies included in the global investable market.

Issue, Security, Company Relationship: an issue is stock-exchange specific. A security can have multiple issues that trade on different exchanges, while a company can have multiple security classes that are traded as different securities.

Local Shares: share of a security traded on its domestic exchange

Market Capitalization: the number of shares outstanding of a company multiplied by their price per share.

Primary Exchange: in general, a primary exchange for a security is a domestic exchange where the security is most liquid. Other factors such as inadequate liquidity on the domestic exchange, incorporation for benefit (tax, etc.), may influence the primary exchange assignment.

Primary Listing: an issue/listing of a security on its primary exchange.

Secondary Listing: an issue/listing of a security on an exchange other than its primary exchange.

Security: an ownership interest or debt interest in a company that was issued by the company and traded in a global market (e.g., the global investable market) as well as derivatives of the ownership interest or debt interest created by the company and/or third parties.

Security Total Market Capitalization: the price of a security on its primary exchange multiplied by the total shares outstanding of the security. Depository receipts may be excluded from the security total market capitalization. However, under some circumstances, depository receipts may be considered in the free-float calculation.

Aspects of the present invention relate to a method of constructing a global market cap-size index. Without being limited by theory, the present invention is based at least in part on an unexpected observation made by the inventors: cap-size effect operates within the global investable market (i.e., a market encompassing all investable securities within the world) in substantially the same manner cap-size effect operates within a single country or region.

Specifically, research has shown that cap-size effect exists across regional boundaries. In other words, companies of similar size tend to behave similarly regardless of geographical location. While cap-size effect is not equally strong across all regions (in particular, cap-size effect is observed less in emerging markets), cross regional cap-size effect appears to be increasing as markets continue to globalize. Therefore, a global cap-size index can be constructed from a collection of stocks traded all over the world without regard to the country/region of origin of the stocks. Securities traded in regions traditionally analyzed separately, such as Europe, Asia, and the like, may be merged together and analyzed as if these securities traded in a single country. According to aspects of the invention, a global cap-size index can be constructed without first constructing a corresponding cap-size index for each country/region separately. In essence, global relative market capitalization may be used to construct global cap-size indexes.

The inventive approach to creating global cap-size indexes may offer one or more of the following advantages over other methods:
1. The size of a country's overall equity market does not prevent an investable security from being eligible for the global index;
2. Selecting securities without regard to country or region, more accurately reflects a financial manager's behavior (managers typically select securities based on a number of criteria first, then look at the security's country of origin); and
3. Selecting by security provides a true representation of the manager's opportunity set.

Additional aspects of the present invention relate to a method of classifying the issuing entities of securities by cap-size. After each company is classified, its securities may be assigned to a corresponding global cap-size index. Much research has focused on determining an appropriate dividing line between large cap companies and small cap companies. However, research in this area has demonstrated that large cap and small cap are not separated by a precise line; instead, the division between large cap and small cap should be established as a range or “band.” In addition to the division between large cap and small cap, other levels of global market capitalization (e.g., mid cap and large cap) may be separated or divided by a band. As used herein, the global market capitalization of a company is its company total market capitalization. Optionally, the company total market capitalization may be free-float adjusted; however, this is not required.

Companies having global market capitalizations above the band are classified as having a first level of global market capitalization (i.e., large cap). Companies having global market capitalizations below the band are classified as having a second level of global market capitalization (i.e., small cap). Companies having a global market capitalization that place them within the band are assigned to a global market capitalization level (e.g., small cap or large cap) according to aspects of the inventive method described below.

As a result of research related to global cap-size effect, cap-size indexes may be constructed that implement a global-relative methodology with banding. Such indexes may include global large cap, global mid cap, and global small cap indexes. This approach is fundamentally different from current industry practice, which determines the cap-size of companies on a country-by-country basis and creates a global index by aggregating companies using country based cap-size. As discussed above, this conventional approach has numerous undesirable drawbacks.

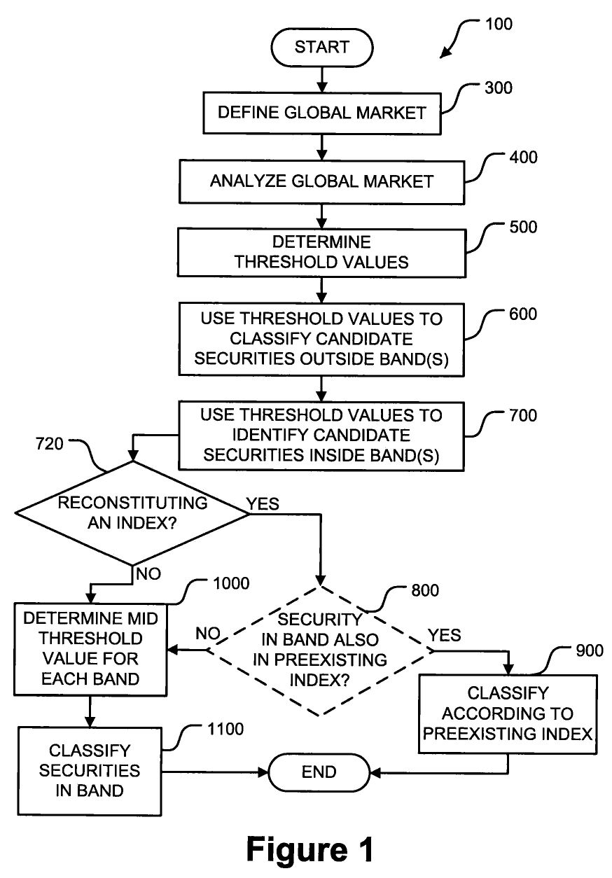

Referring to FIG. 1, aspects of the present invention include a method 100 of assigning securities issued by global entities and/or companies to two or more non-overlapping cap-size indexes (e.g., small cap and large cap). The term “non-overlapping” in this context means that each of the indexes includes a unique set of securities. In other words, none of the securities included in one of the indexes is also included in another of the indexes. Non-limiting exemplary pairs of non-overlapping indexes include (1) a large cap index and a small cap index, (2) a mid cap index and a mega cap index, and the like. Each index represents a predetermined portion of the total global investable market capitalization. The method 100 may be used to construct two or more new cap-size indexes or to reconstitute two or more preexisting cap-size indexes.

In block 300, a global market is identified. Block 300 begins by selecting a pool of candidate securities for inclusion in the global market. The pool includes a plurality of candidate securities each of which is a potential member of at least one of the non-overlapping global cap-size indexes. The pool of candidate securities may be obtained from vendors known to one of ordinary skill in the art as a source of such information. Exemplary vendors of such information include The Thomson Corporation (e.g., The Worldscope Global database) of Stamford, Conn., Telekurs Financial Information, Ltd. (e.g. Valordata feed) of Zurich, Switzerland, and the like.

The pool of candidate securities may be filtered or screened to remove securities not considered to be investable by foreign investors. After the pool of securities has been filtered, the remaining securities represent a global investable market. While the term “global investable market” is used herein to refer to the screened pool of securities, screening is optional. Therefore, the term “global investable market” may also refer to a pool of securities that has not been screened as well as a pool of securities that has been filtered using methods other than those described below.

Methods of screening securities based on their availability for investment by foreign investors are well known to those of ordinary skill and need not be described herein. For example, candidate securities may be screened based on minimum liquidity and/or minimum company total market capitalization requirements.

Minimum liquidity requirements may screen securities that are traded in small volumes and/or are traded infrequently from the pool of candidate securities because such securities may not be considered minimally investable. By way of non-limiting example, two metrics, an Average Daily Trading Volume (“ADTV”) and an Active Trading Ratio (“ATR”) may be used to determine whether a particular security should be screened from the pool of candidate securities. Both of these metrics are calculated with respect to a security's primary exchange.

If a security trades on a single exchange, that exchange is the security's primary exchange. However, if issues of a security are traded on multiple exchanges, all of the exchanges on which the issues trade or a portion thereof may be considered. The candidate exchanges may be evaluated by calculating an Average Daily Trading Volume (“ADTV”) for at least a portion of the issues of each security in the pool. If a security has only a single issue, the ADTV is calculated for that issue. Alternatively, if a security has multiple issues, the ADTV may be calculated for a portion of those issues. For example, if the security has issues traded on one or more domestic exchanges, the ADTV may be calculated for only local (domestic) issues. Alternatively, the ADTV is calculated for all of the issues of a security.

ADTV is calculated by dividing an issue's trading volume accumulated during a predetermined time period by a selected number of days including all or a portion of the predetermined time period. The numerator, the issue's accumulated trading volume, is calculated by totaling the volume of the issue traded on its exchange over the predetermined time period. The trading volume may be measured in any currency, such as United States dollars, euros, and other currencies. Any suitable amount of time may be used as the predetermined time period. For example, the predetermined time period may be about one year. In some embodiments, the denominator (i.e., the selected number of days within the predetermined time period) is equal to the number of days the exchange associated with the issue was open for trading during the predetermined time period. Alternatively, the denominator may be equal to the number of days in the predetermined time period including non-trading days or a subset thereof (e.g., the number of days in the predetermined time period excluding weekends).

Then, the ADTV values of each of the issues of a security associated with a candidate exchange are compared and the exchange associated with the issue having the largest ADTV value is selected as the primary exchange. For example, the ADTV values of all of the local issues may be compared and the domestic exchange associated with the local issue having the largest ADTV value selected as the primary exchange. The issue traded on the primary exchange is the primary issue of the security. The ADTV value of a security is the ADTV value of its primary issue.

Then, the Active Trading Ratio (“ATR”) is calculated for each security in the pool. ATR is calculated by dividing the number of active trading days for the security's primary issue on the primary exchange by a selected number of days including all or a portion of a predetermined time period. The numerator, the number of active trading days, is calculated by totaling the number of days at least one share of the primary issue of the security was traded on its primary exchange within the predetermined time period. Any suitable amount of time may be used as the predetermined time period. For example, the predetermined time period may be about one year. The same predetermined time period may be used to calculate both the ADTV and the ATR or different time periods may be used. In some embodiments, the denominator (i.e., the selected number of days within the predetermined time period) is equal to the number of days the security's primary exchange was open for trading during the predetermined time period. Alternatively, the denominator may be equal to the number of days in the predetermined time period including non-trading days or a subset thereof (e.g., the number of days in the predetermined time period excluding weekends).

Next, the security is evaluated to determine whether it is adequately liquid using a minimum Active Trading Ratio threshold (“minimum ATR threshold”) and a minimum Average Daily Trading Volume threshold (“minimum ADTV threshold”). The minimum ATR threshold may be a predetermined value (e.g., 0.3, 0.45, 0.55, 0.65, 0.7, etc.) that identifies a portion of the days the primary exchange of the security was open for trading on which the primary issue of the security must have been traded. For example, the minimum ATR threshold may be approximately 0.5, which corresponds to the security's primary issue having been traded (e.g., at least one share was traded) on at least half of the days the primary exchange of the security was open for trading. Alternatively, the minimum ATR threshold may range from approximately 0.3 to approximately 0.7.

The predetermined value used for the minimum ATR threshold may be determined empirically from an analysis of the ATR values of a pool of securities. For example, the minimum ATR threshold may be determined by selecting an initial value (e.g., 0.3) and modifying the minimum ATR threshold until ATR values of securities traded infrequently and in large blocks are below the minimum ATR threshold. Any method known by those of ordinary skill in the art may be used to identify securities traded infrequently and in large blocks. Empirical determination of the minimum ATR threshold may also include identifying securities that should be found to be adequately liquid. These securities may be used to determine whether the minimum ATR threshold is too high and thus, is determining that adequately liquid securities are inadequate. Again, the minimum ATR threshold may be modified until ATR values of a satisfactory number of securities traded infrequently and in large blocks are below the minimum ATR threshold and a satisfactory number of adequately liquid securities are above the minimum ATR threshold. Any method known to those of ordinary skill in the art may be used to identify securities that should be found to be adequately liquid.

The minimum ADTV threshold may be calculated as a function of the ADTV values of the securities in the pool. For example, the minimum ADTV threshold may be set to a median ADTV value of the securities in the pool. For 2007, the median ADTV is approximately $150,000 USD. In some embodiments, the minimum ADTV threshold is a median ADTV value of a portion of the securities in the pool that excludes some securities. Non-limiting examples of securities that may be excluded include securities owned by a government, securities that are highly regulated by a government, and the like. Such securities (e.g., public utilities owned by some foreign governments) may be excluded because they have an ‘insulated’ price that is often slow-moving or even static.

The minimum ADTV threshold may be set to statistics other than the median that are calculated as a function of the ADTV values of the securities in the pool, such as a mean, a median, a selected percentile, and the like. Further, constants may be added to such minimum ADTV thresholds. Additionally, the minimum ADTV threshold may be scaled. For example, the minimum ADTV threshold may be set equal to the median ADTV multiplied by a scale factor (e.g., 1.01, 0.98, and the like). It may be desirable to use a consistent formula or method to calculate the minimum ADTV threshold each time the index is reconstituted. In this manner, manual and/or inconsistent adjustment of the minimum ADTV threshold may be avoided. However, if an unusual or onetime event occurs, manual adjustment of the calculated minimum ADTV threshold may be necessary.

If the ADTV of a security is greater than or equal to the minimum ADTV threshold and the ATR of the security is greater than or equal to the minimum ATR threshold, the security is adequately liquid and a primary exchange exists for the security. If the ADTV of the security is less than the minimum ADTV threshold and/or the ATR of the security is less than the minimum ATR threshold, the security may not be adequately liquid. If only a portion of the exchanges on which issues of a security are traded (e.g., only domestic exchanges) were considered in determining the primary exchange of the security, it may be possible that another issue of the security is more liquid. In other words, a secondary issue may be identified as the primary listing and its exchange may be identified as the primary exchange for the inadequately liquid security. If a secondary issue is adequately liquid (i.e., has an ADTV value greater than or equal to the minimum ADTV threshold and an ATR value greater than or equal to the minimum ATR threshold), a primary exchange exists for the security. The adequately liquid secondary issue is identified as the primary issue and the exchange on which that issue trades is identified as the primary exchange.

If the local issues and foreign issues of a security are both found to be inadequately liquid but the security is traded as depository receipts, the depository receipts may be adequately liquid and may be considered the primary issue. In such cases, the exchange on which the adequately liquid depository receipts trade is identified as the primary exchange. Like securities, depository receipts may trade on multiple exchanges. Therefore, ADTV and ATR values for each exchange on which depository receipts trade are calculated. If any of the depository receipts have an ADTV value greater than or equal to the minimum ADTV threshold and an ATR value greater than or equal to the minimum ATR threshold, the security is adequately liquid and a primary exchange exists for the security. The exchange on which adequately liquid depository receipts trade is identified as the primary exchange.

If the security is not adequately liquid with respect to its local issues, foreign issues, and depository receipts, the security is inadequately liquid for inclusion in the pool of securities. Therefore, the security is screened from the pool of securities. Further, a primary exchange does not exist for the security.

Beyond the screen described above to determine whether a security is adequately liquid to be considered investable by foreign investors, other methods known in the art may be used.

The company total market capitalizations of the companies that issued the candidate securities may also be used to screen a portion of the securities from the pool. Minimum company total market capitalization requirements may be used to screen securities from the pool of candidate securities that were issued by companies having a company total market capitalization below a predetermined minimum level. For example, the predetermined minimum level of company total market capitalization may range from about $50,000 USD to about $50,000,000 USD and is preferably about $1,000,000 USD. The minimum company total market capitalization may be determined empirically by experimenting with different values and identifying a value that screens companies for which screening is desired and fails to screen companies for which screening is not desired. Minimum company total market capitalization requirements may be used to screen extremely small equity securities that are effectively inaccessible to institutional investors from the pool of candidate companies.

Additionally, the safety and/or stability of the overall investment environment within a country from which a candidate security originates may be used to screen securities from the pool of candidate securities. Some countries do not provide sufficiently stable environments for institutional investment and for this reason, securities originating therefrom may be screened from the pool of candidate securities.

Methods of determining the adequacy of the investability conditions in a country are well known to those of ordinary skill in the art and the invention is not limited by the method used. For example, investability conditions in a country may be evaluated using a group of factors and reference materials. These factors include the country's political stability, capital market policies, corporate governance, competitiveness, de facto operating conditions, and trends in transaction volume and liquidity. Turning to reference materials, country risk ratings published by the Economist Intelligence Unit (“EIU”) division of The Economist Newspaper Limited of London, England, may be used to evaluate the safety and/or stability of the overall investment environment within a country. EIU is a leading international risk advisory service associated with The Economist newspaper, which is published by The Economist Newspaper Limited of London, England. EIU rates country risk by combined economic and political risk on a 100-point scale. Securities from countries considered high risk by EIU (e.g., category “D” or “E” countries) may be screened from the candidate companies.

In some embodiments, securities that are not equity or equity-like securities may be screened from the pool of candidate securities. Equity-like securities are those that represent ownership of a company without an obligation for the company to repay invested capital in the form of coupon payments or lump sum payments throughout the life of the investment. By way of example, the following types of securities may not be considered equity securities and may be excluded from the plurality of candidate securities:
1. Warrants and Rights
2. Trust Receipts and Royalty Trusts
3. Depository Receipts (with the exception of Depository Receipts for securities from The Philippines, Russia, and Thailand)
4. Limited Liability Companies
5. Closed-end Investment Companies
6. Limited Partnerships
7. Exchange Traded Funds (ETFs) and mutual funds

Additionally, some Bulletin Board as well as Pink Sheet Stocks and foreign equivalents thereto may be excluded if they are traded on an ineligible stock exchange. Pink Sheet stocks are over-the-counter (“OTC”) securities that do not meet the listing standards required to trade on major stock exchanges due to their limited capitalization and/or the limited number of shares outstanding. With a few exceptions, Pink Sheet stocks are small, thinly-traded issues that often carry a great deal of risk. Most Pink Sheet stocks are not very liquid. A Bulletin Board is an electronic quotation listing of the bid and asked prices of over the counter stocks that do not meet the requirements to be listed on the main board of an exchange.

An exemplary pool of candidate securities (e.g., share classes) organized by country is provided in Appendix A. The pool of candidate securities provided in Appendix A was determined as of July 2007.

Further, a portion of the securities may be removed from the pool of candidate securities. By way of non-limiting example, the smallest 2% of securities (as measured by security total market capitalization) may be removed from the pool. Alternatively, the smallest 0.5% of securities to the smallest 10% of securities may be removed from the pool.

If the method 100 is being used to reconstitute preexisting indexes, the pool of candidate securities selected in block 300 may include securities that were already included in the preexisting indexes.

Block 400 analyzes the global investable market (i.e., the securities that were not screened from the pool of candidate securities in block 300) and the global market capitalization (i.e., company total market capitalization) of the companies issuing the securities therein. In some embodiments, one or more statistical analyses are performed on the global investable market. For example, block 400 may determine levels of global market capitalization corresponding to percentiles of the global market capitalizations of all of the companies issuing the securities in the global investable market. By way of non-limiting example, the level of global market capitalization corresponding to the 95th percentile of the global market capitalizations of the companies issuing securities in the global investable market may be determined in block 400. Block 400 may also determine other statistics such as the mean, median, mode, and the like of the global market capitalizations of the companies issuing securities in the global investable market.

Optionally, the securities within the global investable market are ranked according to the global market capitalization of the companies that issued the securities. For example, in block 400, the securities may be ranked in descending order of global market capitalization of the companies that issued the securities. This ranking may be useful in conceptualizing the global investable market and/or selecting securities issued by companies having global market capitalizations above or below a predetermined level. However, as is apparent to those of ordinary skill in the art, ranking candidate securities is not required to select securities issued by companies having global market capitalizations above or below a predetermined level.

As discussed above, cap-sizes (e.g., large cap and small cap) are divided by a band. A pair of threshold values defines each band. In block 500, a pair of threshold values for each band is determined. For example, if a single band is present (as is the case when the securities of the global investable market are divided into securities issued by small cap companies and securities issued by large cap companies), in block 500, a lower threshold value and an upper threshold value may be determined. The lower threshold value and upper threshold value may both correspond to a predetermined percentile of the global market capitalizations of the companies that issued the securities in the global investable market.

Total global investable market capitalization is the sum of the global market capitalizations of the companies that issued the securities in the global investable market. A total global investable market capitalization range or band exists between the upper and lower threshold values. A portion of the securities of the global investable market was issued by companies having global market capitalizations falling within the band. The difference between the upper threshold value and the lower threshold value (i.e., the width of the band) may be about 2% of the total global investable market capitalization to about 10% of the total global investable market capitalization. In some embodiments, the difference between the upper threshold value and the lower threshold value may be about 5% of the total global investable market capitalization.

The upper threshold value may range from approximately the 50th percentile to approximately the 90th percentile of the global market capitalizations of the global investable market. In some embodiments, the upper threshold value may be the 85th percentile of the global market capitalizations of the global investable market. For example, if the pair of indexes includes a large cap index and a small cap index, the upper threshold value may be the 85th percentile of the global market capitalizations of the global investable market. Alternatively, the upper threshold value may be the 55th percentile of the global market capitalizations of the global investable market. For example, if the pair of indexes includes a mega cap index and a mid cap index, the upper threshold value may be the 55th percentile.

The lower threshold value may be smaller than the upper threshold value. The lower threshold value may range from approximately the 55th percentile of the global market capitalizations of the global investable market to approximately the 95th percentile of the global market capitalizations of the global investable market. In some embodiments, the lower threshold value may be the 90th percentile of the global market capitalizations of the global investable market. For example, if the pair of indexes includes a large cap index and a small cap index, the lower threshold value may be the 90th percentile. Alternatively, the lower threshold value may be the 60th percentile of the global market capitalizations of the global investable market. For example, if the pair of indexes includes a mega cap index and a mid cap index, the lower threshold value may be the 60th percentile.

The method 100 may treat securities issued by dual-listed companies as two separate securities. Therefore, securities issued by dual-listed companies may be assigned to different cap-size indexes. However, different types of securities issued by the same company are assigned to the same cap-size index.

In block 600, the threshold value(s) are used to classify the securities of the global investable market. For example, any company having a global market capitalization less than the lower threshold value may be classified as a first level security. Similarly, any security issued by a company having a global market capitalization greater than the upper threshold value may be classified as a second level security. If the upper threshold value was the 90th percentile and the lower threshold value was the 85th percentile, a first level security is a small cap security (issued by a small cap company) and a second level security is a large cap security (issued by a large cap company). Alternatively, if the upper threshold value was the 60th percentile and the lower threshold value was the 55th percentile, a first level security is a mid cap security and a second level security is a mega cap security.

In block 700, the threshold value(s) are used to identify the portion of the securities issued by companies having global market capitalizations within the band. For example, block 700 may identify securities issued by companies having a global market capitalization greater than or equal to the lower threshold value and a global market capitalization less than or equal to the upper threshold value.

Optional decision block 800 applies if the method 100 is being used to reconstitute a preexisting index. Therefore, decision block 720 determines whether a preexisting index is being reconstituted. If a preexisting index is being reconstituted, the method 100 advances to optional decision block 800. Otherwise, the method 100 advances to block 1000.

In decision block 800, the securities in the portion of securities identified in block 700 are compared to one or more preexisting indexes. In block 900, each security that was classified previously (i.e., before the current reconstitution), is reclassified with that previous classification. In other words, the classification of those securities is not changed in block 900. For example, if a security was a member of a first level index (e.g., a small cap index), the security is reclassified as a first level security in block 900 and will remain a member of the first level index. The method 100 then advances to block 1000.

In block 1000, a mid threshold value is determined for each band. For a particular band, a mid threshold value may include the average value of the threshold values flanking the band. For example, if a single band is present (as is the case when the securities of the global investable market are divided into small cap companies and large cap companies), block 1000 may determine a single mid threshold value that is the average of the lower threshold value and the upper threshold value (e.g., if the upper threshold value is the 85th percentile and the lower value is the 90th percentile, the mid threshold value may be the 87.5 percentile).

In block 1100, the mid threshold value(s) determined in block 1000 are used to classify at least a portion of the securities issued by companies having global market capitalizations within a band. If the method 100 is being used to reconstitute an index, the block 1100 classifies a portion of the securities issued by companies having global market capitalizations within the band that were not previously classified (i.e., before the current reconstitution). If the method 100 is not being used to reconstitute an index, the block 1100 may classify all of the securities issued by companies having global market capitalizations within the band.

The mid threshold value is used to classify the securities issued by companies within the band into one of the capitalization levels that flank the band. For example, a security issued by a company having a global market capitalization greater than or equal to the mid threshold value may be classified as a second level (e.g., large cap) security. A security issued by a company having a global market capitalization less than the mid threshold value may be classified as a first level (e.g., small cap) security.

At this point, the method 100 has classified all securities of the global investable market into a market capitalization level (i.e., a cap-size) that corresponds to one of the non-overlapping indexes. After the securities have been classified into a market capitalization level, optionally, one or more sub-indexes may be created from that market capitalization level. For example, the securities within a market capitalization level may be divided by country, region, or combinations thereof. By way of non-limiting example, securities classified as first level (e.g., small cap) securities may be divided into first level securities from Asia, Europe, Asia Pacific, North America, and Latin America. Additional non-limiting examples include dividing securities into first level securities from one or more countries (e.g., Japan, United States, Mexico, etc.). Other subdivisions of a particular market capitalization level known to those of ordinary skill in the art are within the scope of the present invention.

While the embodiment described determines a single pair of threshold values (i.e., the upper threshold value and the lower threshold value) that define a single band, it is apparent to those of ordinary skill in the art that additional pairs of threshold values may be determined. For example, block 500 may determine four threshold values: an upper threshold value; an upper-mid threshold value; a lower-mid threshold value; and a lower threshold value. In such embodiments, any security issued by a company having a global market capitalization less than the lower threshold value may be classified as a first level company. Any security issued by a company having a global market capitalization greater than the upper threshold value may be classified as a fourth level company. Finally, any security issued by a company having a global market capitalization greater than the lower-mid threshold value and lower than the upper-mid threshold value may be classified as a third level company. In this example, two bands are present. A first band is located between the lower-mid threshold value and the lower threshold value and a second band is located between the upper-mid threshold value and the upper threshold value. Securities issued by companies having global market capitalizations within each of these bands may be handled in block 700 in the same manner the band between the lower threshold value and the upper threshold value is handled in the above example.

Optionally, securities issued by companies from one or more selected countries may be analyzed separately in block 400. Ranking securities from one or more selected country separately may facilitate comparisons between a distribution of the global market capitalizations of those countries and a distribution of the aggregate global market capitalization of the remainder of the world. For example, securities issued by companies from the U.S. and Japan may be analyzed separately. As mentioned above a pair of threshold values defines each band. If the securities of the global investable market are divided into securities issued by small cap companies and securities issued by large cap companies, the upper threshold value may be the 85th percentile and the lower threshold value may be the 90th percentile. Therefore, the mid threshold value may be the 87.5th percentile. The inventors have observed that when the global market capitalizations of companies from the U.S. and Japan are analyzed separately, various statistical values, such as the 87.5th percentile, are substantially equivalent in the U.S. market, Japan market, and the remaining global investable market (i.e., the global investable market excluding the U.S. and Japan markets). Therefore, the 87.5th percentile of the U.S. and Japanese markets fall within the band dividing the large cap-size companies and small-cap size companies in the remaining global markets. Under such circumstances, the process of constructing the indexes divided by the band may be modified to include analyzing one or more markets separately provided the separate market analyses produce substantially similar mid threshold values, thereby approximating the mid threshold values of the remainder of the market.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

APPENDIX A
(determined as of July 2007)

| Country | Eligible Share Classes |
|---|---|
| Argentina | Common Shares |
| Australia | Common shares |
| | Preferred shares |
| Austria | Common shares |
| | Preferred shares |
| | Participation certificates |
| Bahrain | Common Shares |
| Belgium | Common shares |
| | Preferred shares |
| Botswana | Common Shares |
| Brazil | Common shares |
| | Preferred shares |
| Bulgaria | Common Shares |
| Canada | Common Shares |
| | Units of Income Trusts |
| Chile | Common shares |
| | Preferred shares |
| China | B shares |
| | H shares |
| | N shares |
| Colombia | Common shares |
| | Preferred shares |
| Croatia | Common Shares |
| Cyprus | Common Shares |
| Czech Republic | Common Shares |
| Denmark | A shares |
| | B shares |
| Egypt | Common Shares |
| Estonia | Common shares |
| | Preferred shares |
| Finland | A shares |
| | B shares |
| | K shares |
| France | Common shares |
| | Preferred shares |
| | Investment certificates |
| | Voting certificates |
| Germany | Common shares |
| | Preferred shares |
| Ghana | Common Shares |
| Greece | Common shares |
| | Preferred shares |
| Hong Kong | A shares |
| | B shares |
| Hungary | Common Shares |
| Iceland | Common Shares |
| India | Common Shares |
| Indonesia | Common Shares |
| Ireland | Common Shares |
| Israel | Common shares |
| | Preferred shares |
| | ADRs |
| Italy | Common shares |
| | Preferred shares |
| | Savings shares |
| Japan | Common shares |
| Jordan | Common shares |
| Kuwait | Common shares |
| Latvia | Common shares |
| Lithuania | Common shares |
| Luxembourg | Common shares |
| Malaysia | Common shares |
| Mauritius | Common shares |
| Mexico | Common shares |
| | Participation certificate |
| Morocco | Common shares |
| Netherlands | Common shares |
| | Preferred shares |
| New Zealand | Common shares |
| | Preferred shares |
| Norway | A shares |
| | B shares |
| | Primary Capital Certificates |
| Oman | Common shares |
| Pakistan | Common shares |
| Peru | Common shares |
| | Preferred shares |
| | Investment shares |
| Philippines | Common shares |
| Poland | Common shares |
| Portugal | Common shares |
| Qatar | Common shares |
| Romania | Common shares |
| Russia | Common shares |
| | Preferred shares |
| Singapore | Common shares |
| Slovenia | Common shares |
| South Africa | Common shares |
| | Preferred shares |
| South Korea | Common shares |
| | Preferred shares |
| Spain | Common shares |
| Sri Lanka | Common shares |
| Sweden | A shares |
| | B shares |
| | C shares |
| Switzerland | Registered shares |
| | Bearer shares |
| | Participation certificates |
| | Dividend-right certificates |
| Taiwan | Common shares |
| | Preferred shares |
| Thailand | Common shares |
| | Preferred shares |
| Turkey | Common shares |
| United Arab Emirates | Common shares |
| United Kingdom | Common shares |
| United States | Common shares |
| Zambia | Common shares |

The invention claimed is:

1. A method comprising:
aggregating securities traded in a plurality of regions of the world into a single pool of securities;
determining a global market capitalization associated with each security in the pool of securities;
determining a first threshold value as a function of the global market capitalizations associated with the securities in the pool of securities; and
assigning a portion of the securities in the pool of securities to a first global relative market index based on the global market capitalization associated with each security in the pool of securities and the first threshold value.

2. The method of claim 1, wherein assigning the portion of the securities in the pool of securities to the first global relative market index comprises assigning each security in the pool of securities having a global market capitalization greater than the first threshold value to the first global relative market index.

3. The method of claim 1, wherein assigning the portion of the securities in the pool of securities to the first global relative market index comprises assigning each security in the pool of securities having a global market capitalization less than the first threshold value to the first global relative market index.

4. The method of claim 3, further comprising:
determining a second threshold value as a function of the global market capitalizations associated with the securities in the pool of securities; and
assigning each security in the pool of securities having a global market capitalization greater than the second threshold value to a second global relative market index.

5. The method of claim 4, further comprising:
determining a third threshold value as a function of the global market capitalizations associated with the securities in the pool of securities;
identifying a band portion of securities in the pool of securities associated with a global market capitalization greater than the first threshold value and less than the second threshold value; and
for each security within the band portion,
if the security was assigned previously to the first global relative market index, assign the security to the first global relative market index,
if the security was assigned previously to the second global relative market index, assign the security to the second global relative market index,
if the security was not assigned previously to either the first global relative market index or the second global relative market index and the global market capitalization associated with the security is below the third threshold value, assign the security to the first global relative market index, and
if the security was not assigned previously to either the first global relative market index or the second global relative market index and the global market capitalization associated with the security is above the third threshold value, assign the security to the second global relative market index.

6. The method of claim 1, wherein the first threshold value is a percentile of the global market capitalizations associated with the securities in the pool of securities.

7. The method of claim 6, wherein the first threshold value is the 90th percentile, 85th percentile, 60th percentile, or 55th percentile.

8. The method of claim 1, wherein determining the first threshold value as a function of the global market capitalizations associated with the securities in the pool of securities comprises performing a statistical analysis on the global market capitalizations associated with the securities in the pool of securities and using a result of the statistical analysis as the first threshold value.

9. The method of claim 1, wherein each security in the pool of securities was issued by an issuing company having a company total market capitalization, and for each security in the pool of securities, the global market capitalization associated with the security is the company total market capitalization of the issuing company of the security.

10. The method of claim 1, wherein each of the securities assigned to the first global relative market index is associated with a country, the method further comprising:
assigning a portion of the securities in the first global relative market index to a second market index based on the countries associated with each of the securities in the portion of the securities in the first global relative market index.

11. A method of constructing a first global cap-size index for a first plurality of issuing entities each having at most a first market capitalization and a second global cap-size index for a second plurality of issuing entities each having at least a second market capitalization, the first market capitalization being less than the second market capitalization, the method comprising:
selecting a plurality of global securities, each security of the plurality of global securities having been issued by an issuing company;
determining the global market capitalization of each issuing company;
determining the first market capitalization as a function of the global market capitalizations of the issuing companies of the securities in the plurality of global securities;
determining the second market capitalization as a function of the global market capitalizations of the issuing companies of the securities in the plurality of global securities; and
for each security of the plurality of global securities,
if the global market capitalization of the issuing company of the security is less than the first market capitalization, assigning the security to the first global cap-size index, and
if the global market capitalization of the issuing company of the security is greater than the second market capitalization, assigning the security to the second global cap-size index.

12. The method of claim 11, wherein the plurality of global securities are selected from a plurality of securities traded in Europe, Asia, Asia Pacific, North America, and South America.

13. The method of claim 11, wherein determining the first market capitalization as a function of the global market capitalizations of the issuing companies of the securities in the plurality of global securities comprises performing a statistical analysis on the global market capitalizations of the issuing companies of the securities in the plurality of global securities, obtaining a first result and a second result from the statistical analysis, and using the first result of the statistical analysis as the first market capitalization, and determining the second market capitalization as a function of the global market capitalizations of the issuing companies of the securities in the plurality of global securities comprises using the second result of the statistical analysis as the second market capitalization.

14. The method of claim 13, wherein the first result of the statistical analysis comprises a predetermined percentile of the global market capitalizations of the issuing companies of the securities in the plurality of global securities.

15. The method of claim 13, wherein the second result of the statistical analysis comprises a predetermined percentile of the global market capitalizations of the issuing companies of the securities in the plurality of global securities.

16. A plurality of cap-size indexes constructed from a pool of global securities, each security in the pool having been issued by an issuing company, the plurality of cap-size indexes comprising:
a first index comprising a first portion of the global securities in the pool of global securities, the issuing company of each security of the first portion of global securities having a global market capitalization greater than a first threshold value, the first threshold value having been determined as a function of the global market capitalizations of the issuing companies of the securities in the pool of global securities; and
a second index comprising a second portion of the global securities in the pool of global securities, the issuing company of each security of the second portion of global securities having a global market capitalization less than a second threshold value, the second threshold value having been determined as a function of the global market capitalizations of the issuing companies of the securities in the pool of global securities.

17. The plurality of cap-size indexes of claim 16, wherein
the second threshold value is less than the first threshold value,
the first index comprises a first portion of a band portion of the global securities, the band portion of the global securities comprising securities issued by issuing companies having a global market capitalization less than a first threshold value and greater than a second threshold value,
the second index comprises a second portion of the band portion of the global securities, and
the first portion of the band portion is non-overlapping with the second portion of the band portion.

18. A method of reconstituting a plurality of global cap-size indexes, the plurality of global cap-size indexes comprising a first index and a second index, each of the first index and second index comprising an initial set of global securities, the method comprising:
aggregating securities traded in a plurality of regions of the world into a single pool of securities;
determining a global market capitalization associated with each security in the pool of securities;
determining a first threshold value, a second threshold value, and a third threshold value as a function of the global market capitalizations associated with the securities in the pool of securities, the first threshold value being greater than the second threshold value and the third threshold value, the third threshold value being greater than the second threshold value;
replacing the securities in the initial set of global securities of the first index with a new set of global securities, the new set comprising securities in the pool of securities associated with a global market capitalization greater than the first threshold;
replacing the securities in the set of global securities of the second index with a new set of global securities, the new set comprising securities in the pool of securities associated with a global market capitalization less than the second threshold; and
for each security in the pool of securities associated with a global market capitalization less than a first threshold and greater than a second threshold,
if the initial set of global securities of the first index included the security, adding the security to the new set of global securities of the first index,
if the initial set of global securities of the second index included the security, adding the security to the new set of global securities of the second index, and
if neither the initial set of global securities of the first index nor the initial set of global securities of the second index included the security,
adding the security to the first index if the global market capitalization associated with the security is greater than the third threshold, and
adding the security to the second index if the global market capitalization associated with the security is less than the third threshold.

19. A global cap-size index comprising:
a plurality of global securities selected from a plurality of regions of the world, each security in the plurality of global securities being associated with a global market capitalization, and each security in the plurality of global securities having been assigned to the global cap-size index using a threshold value calculated as a function of the global market capitalizations associated with the securities in the plurality of global securities.

20. The method of claim 19, wherein the plurality of regions of the world comprise Europe, Asia, Asia Pacific, North America, and South America.

21. The index of claim 19, wherein each security in the plurality of global securities has a global market capitalization greater than the threshold value.

22. The index of claim 19, wherein each security in the plurality of global securities has a global market capitalization less than the threshold value.

23. The index of claim 19, wherein the threshold value comprises a percentile of the global market capitalizations associated with the securities in the plurality of global securities.

24. The index of claim 19, further comprising:
a plurality of sub-indexes each comprising a portion of the plurality of global securities, each of the securities in the portion being associated with the same region in the plurality of regions of the world.

25. The index of claim 19, further comprising:
a plurality of sub-indexes each comprising a portion of the plurality of global securities, each of the securities in the portion being associated with a selected country.
